(19) United States
(12) Patent Application Publication
(10) Pub. No.: US 2018/0056579 A1
(43) Pub. Date: Mar. 1, 2018

(54) THREE-DIMENSIONAL OBJECT AND THREE-DIMENSIONAL OBJECT MANUFACTURING METHOD

(71) Applicant: MIMAKI ENGINEERING CO., LTD., Nagano (JP)

(72) Inventors: Kenji HARAYAMA, Nagano (JP); Yoshihiro TANAKA, Nagano (JP); Keita NISHIO, Nagano (JP); Katsutoshi YAMABE, Nagano (JP)

(21) Appl. No.: 15/689,586

(22) Filed: Aug. 29, 2017

(30) Foreign Application Priority Data
Aug. 31, 2016 (JP) 2016-169344

(51) Int. Cl. B29C 64/10; B33Y 10/00; B33Y 70/00

(52) U.S. Cl. CPC B29C 64/10; B29L 2023/22; B33Y 70/00; B33Y 10/00

(57) ABSTRACT

To provide a three-dimensional object and a three-dimensional object manufacturing method that can facilitate handling compared to the conventional art even if the object is large. A three-dimensional object includes a frame and parts to be attached to the frame, where the parts each includes a tubular body interiorly formed with a cavity, and at least one part of the frame is arranged in the cavity.

### CROSS REFERENCE TO RELATED APPLICATIONS

This application claims the priority benefit of Japanese Patent Application No. 2016-169344, filed on Aug. 31, 2016. The entirety of the above-mentioned patent application is hereby incorporated by reference herein and made a part of this specification.

### TECHNICAL FIELD

The present disclosure relates to a three-dimensional object, which is a three-dimensionally shaped object, and a three-dimensional object manufacturing method.

### DESCRIPTION OF THE BACKGROUND ART

A full scale bust, and the like is known for the conventional three-dimensional object (see e.g., Japanese Unexamined Patent Publication No. 2003-196486).

### SUMMARY

However, if the three-dimensional object is a large object such as a full scale model, and the like of an object having a size of greater than or equal to a human, the three-dimensional object becomes heavy and becomes difficult to handle when being conveyed and installed.

The present disclosure provides a three-dimensional object and a three-dimensional object manufacturing method that can facilitate handling compared to the conventional art even if the object is large.

A three-dimensional object of the present disclosure includes: a frame, and a plurality of parts to be attached to the frame.

According to such a configuration, the three-dimensional object of the present disclosure can be broken down by being divided into the frame and the plurality of parts, and thus can be easily handled when being conveyed and installed compared to the conventional art even if the object is large.

In the three-dimensional object of the present disclosure, the part may include a tubular body interiorly formed with a cavity, and at least one part of the frame may be arranged in the cavity.

According to such a configuration, the three-dimensional object of the present disclosure can facilitate the handling as the parts are easily joined together.

In the three-dimensional object of the present disclosure, when the plurality of parts are overlapped in a vertical direction, a thickness in a horizontal direction may become thicker toward a lower side in the vertical direction.

According to such a configuration, when the plurality of parts are overlapped in the vertical direction, the thickness in the horizontal direction becomes thinner toward the upper side in the vertical direction of the parts, and hence the three-dimensional object of the present disclosure can be made lighter. When the plurality of parts are overlapped in the vertical direction, the thickness in the horizontal direction becomes thicker toward the lower side in the vertical direction of the parts, and hence the three-dimensional object of the present disclosure can easily support the weight on the upper side in the vertical direction with the lower side, and can also enhance the durability.

In the three-dimensional object of the present disclosure, when the plurality of parts are overlapped in the vertical direction, the thickness in the horizontal direction may become thicker on an interior side of the three-dimensional object toward the lower side in the vertical direction.

According to such a configuration, the three-dimensional object of the present disclosure can realize lighter weight and enhancement of durability while maintaining the exterior shape.

In the three-dimensional object of the present disclosure, one of the frame or the part may include a protrusion formed with a groove, and the other one of the frame or the part may include an engagement portion detachably attached to the groove.

According to such a configuration, the three-dimensional object of the present disclosure can facilitate the detachment/attachment of the parts with respect to the frame.

A three-dimensional object manufacturing method of the present disclosure relates to a three-dimensional object manufacturing method for manufacturing the three-dimensional object, where the frame and the part are formed by three-dimensional printing.

According to such a configuration, in the three-dimensional object manufacturing method of the present disclosure, not only the parts but also the frame is formed by the three-dimensional printing, and hence the degree of freedom of design can be enhanced.

In the three-dimensional object manufacturing method of the present disclosure, a material configuring the frame may have a higher strength than a material configuring the part.

According to such a configuration, the three-dimensional object manufacturing method of the present disclosure can enhance the durability of the three-dimensional object as the frame is formed at higher strength.

The three-dimensional object and the three-dimensional object manufacturing method of the present disclosure can facilitate the handling compared to the conventional art even if the object is large.

### BRIEF DESCRIPTION OF THE DRAWINGS

FIG. 1 is a front cross-sectional view of one part of a three-dimensional object according to one embodiment of the present disclosure.

FIG. 2 is a plan view of one part of the three-dimensional object shown in FIG. 1.

FIG. 3 is a front view of a 3D printer that manufactures at least some of the components of the three-dimensional object shown in FIG. 1.

FIG. 4 is a block diagram of the 3D printer shown in FIG. 3.

FIG. 5 is a front cross-sectional view of one part of the three-dimensional object in an example different from the example shown in FIG. 1.

FIG. 6 is a front view of one part of a three-dimensional object different from the three-dimensional object shown in FIG. 1.

FIG. 7 is a perspective view of one part of the three-dimensional object of when observed from an exterior side of a three-dimensional object different from the three-dimensional objects shown in FIGS. 1 and 6.

FIG. 8A is a perspective view of parts of when observed from an interior side of the three-dimensional object shown in FIG. 7. FIG. 8B is a rear view of the parts shown in FIG. 8A of when observed from the interior side of the three-dimensional object.

FIG. 9 is a perspective view of one part of a frame of the three-dimensional object of when observed from the exterior side of the three-dimensional object shown in FIG. 7 with the parts detached.

### DETAILED DESCRIPTION OF EMBODIMENTS

Hereinafter, one embodiment of the present disclosure will be described with reference to the drawings.

First, a configuration of a three-dimensional object according to the present embodiment will be described.

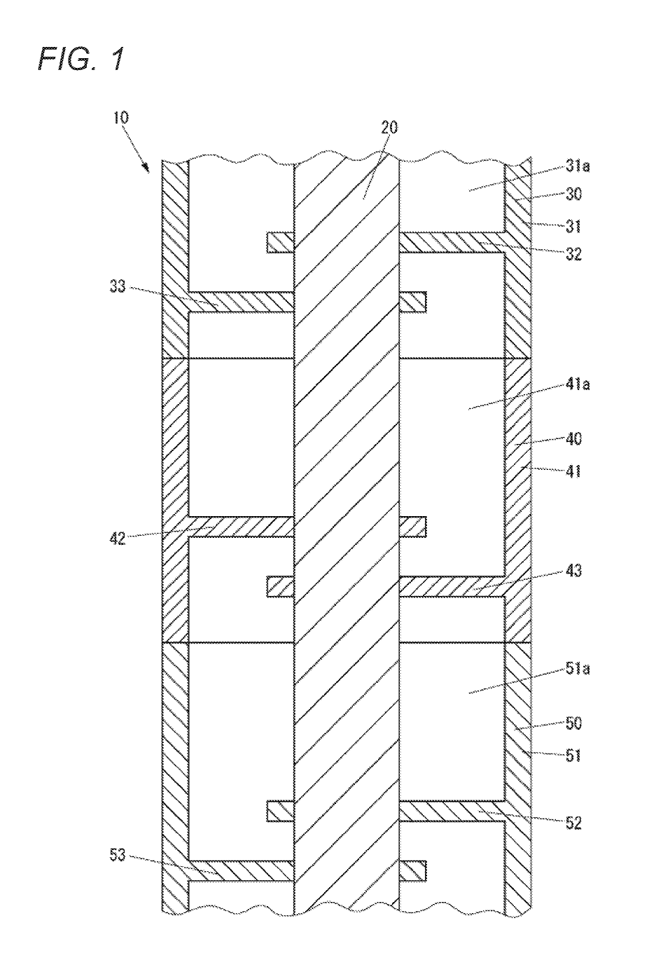

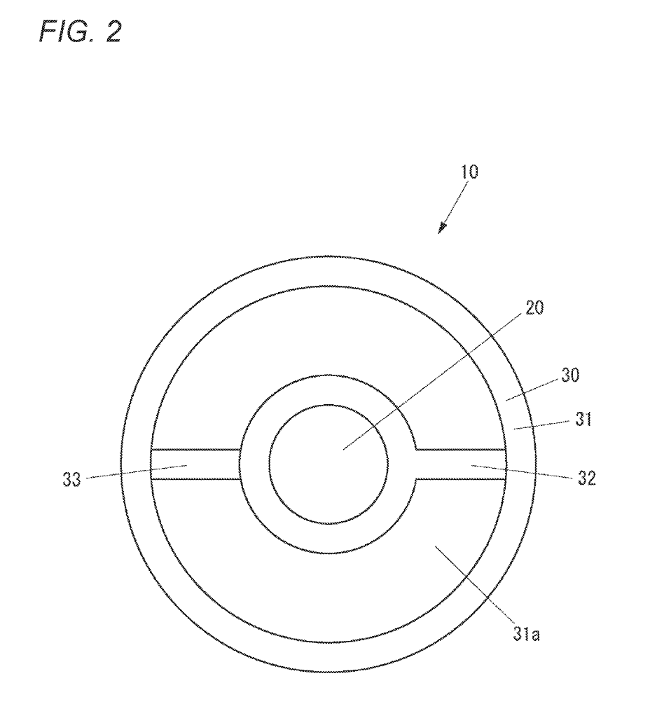

FIG. 1 is a front cross-sectional view of one part of a three-dimensional object 10 according to the present embodiment. FIG. 2 is a plan view of one part of the three-dimensional object 10.

As shown in FIGS. 1 and 2, the three-dimensional object 10 includes a frame 20, and a plurality of parts including parts 30, 40, and 50 to be attached to the frame 20.

The frame 20 is a rod-shaped member. The frame 20 may have an end fixed to any of the parts. The frame 20 preferably has a higher strength than the parts. For example, the frame 20 may have a high strength by being formed thicker than the parts, or may have a high strength by being formed with a material of higher strength than the parts.

The part 30 includes a tubular body 31 interiorly formed with a cavity 31a, and an attachment part 32 and an attachment part 33 attached to the frame 20 by having the frame 20 inserted therein. The attachment part 32 and the attachment part 33 are integrally formed with the tubular body 31, and arranged inside the cavity 31a. At least one part of the frame 20 is arranged inside the cavity 31a.

The part 40 includes a tubular body 41 interiorly formed with a cavity 41a, and an attachment part 42 and an attachment part 43 attached to the frame 20 by having the frame 20 inserted therein. The attachment part 42 and the attachment part 43 are integrally formed with the tubular body 41, and arranged inside the cavity 41a. At least one part of the frame 20 is arranged inside the cavity 41a.

The part 50 includes a tubular body 51 interiorly formed with a cavity 51a, and an attachment part 52 and an attachment part 53 attached to the frame 20 by having the frame 20 inserted therein. The attachment part 52 and the attachment part 53 are integrally formed with the tubular body 51, and arranged inside the cavity 51a. At least one part of the frame 20 is arranged inside the cavity 51a.

A method for manufacturing the three-dimensional object 10 will now be described.

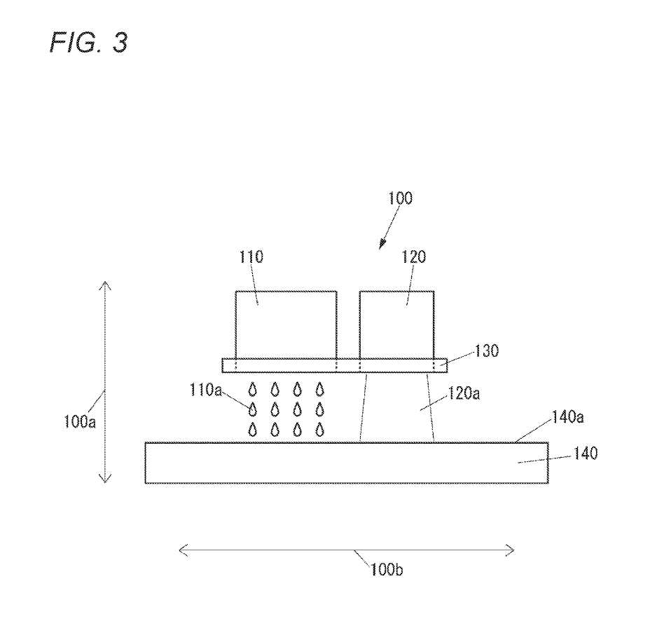

FIG. 3 is a front view of a 3D printer 100 that manufactures at least some of the components of the three-dimensional object 10.

As shown in FIG. 3, the 3D printer 100 includes a carriage 130 mounted with a plurality of ink jet heads 110 that discharge an ultraviolet curing type ink (hereinafter referred to as “UV ink”) 110a toward a lower side in a vertical direction indicated with an arrow 100a, and an ultraviolet irradiating device 120 that irradiates the UV ink 110a discharged by the ink jet head 110 with an ultraviolet ray 120a.

In FIG. 3, only one ink jet head 110 is illustrated. Actually, however, the 3D printer 100 may include, for example, the ink jet head 110 for every type of UV ink 110a.

The UV ink 110a includes, for example, a shaping ink that becomes a material of a 3D object, and a support ink that becomes a material of a support portion for supporting the 3D object to form the 3D object of an arbitrary shape with the shaping ink. The shaping ink may be a color ink that forms a surface portion of the 3D object, and a white ink that forms the interior of the 3D object for color development by the color ink. The support ink is, for example, an ink that can be easily removed with a specific liquid such as water. In the 3D printer 100, the support portion is formed on the lower side in the vertical direction and in a horizontal direction with respect to the 3D object. For example, if the 3D object has an overhang portion, the support portion is formed on the lower side in the vertical direction with respect to the overhang portion to support the overhang portion.

The 3D printer 100 includes a table 140 formed with a supporting surface 140a that supports the 3D object formed by the UV ink 110a discharged by the ink jet head 110 and cured with the ultraviolet ray 120a from the ultraviolet irradiating device 120, and the support portion.

The supporting surface 140a is extended in the horizontal direction as indicated with an arrow 100b.

One of the carriage 130 or the table 140 is relatively movable in the horizontal direction with respect to the other one.

For example, if the carriage 130 is supported by a mechanism (not illustrated) so as to be movable in a main scanning direction of the horizontal direction, the carriage 130 is relatively movable in the main scanning direction with respect to the table 140. In the following, an example in which the carriage 130 is relatively moved in the main scanning direction with respect to the table 140 by being moved in the main scanning direction will be described, but the table 140 may be relatively moved in the main scanning direction with respect to the carriage 130 by being moved in the main scanning direction, and one of the carriage 130 or the table 140 may be relatively moved in the main scanning direction with respect to the other one by being moved, respectively, in the main scanning direction.

Furthermore, the carriage 130 is relatively movable in a sub-scanning direction with respect to the table 140 by being supported by a mechanism (not illustrated) so as to be movable in the sub-scanning direction orthogonal to the main scanning direction of the horizontal direction. In the following, an example in which the carriage 130 is relatively moved in the sub-scanning direction with respect to the table 140 by being moved in the sub-scanning direction will be described, but the table 140 may be relatively moved in the sub-scanning direction with respect to the carriage 130 by being moved in the sub-scanning direction, and one of the carriage 130 or the table 140 may be relatively moved in the sub-scanning direction with respect to the other one by being moved, respectively, in the sub-scanning direction.

One of the carriage 130 or the table 140 is relatively movable in the vertical direction with respect to the other one. For example, if the table 140 is supported by a mechanism (not illustrated) so as to be movable in a vertical direction, the table 140 is relatively movable in the vertical direction with respect to the carriage 130. In the following, an example in which the table 140 is relatively moved in the vertical direction with respect to the carriage 130 by being moved in the vertical direction will be described, but the carriage 130 may be relatively moved in the vertical direction with respect to the table 140 by being moved in the vertical direction, and one of the carriage 130 or the table 140 may be relatively moved in the vertical direction with respect to the other one by being moved, respectively, in the vertical direction.

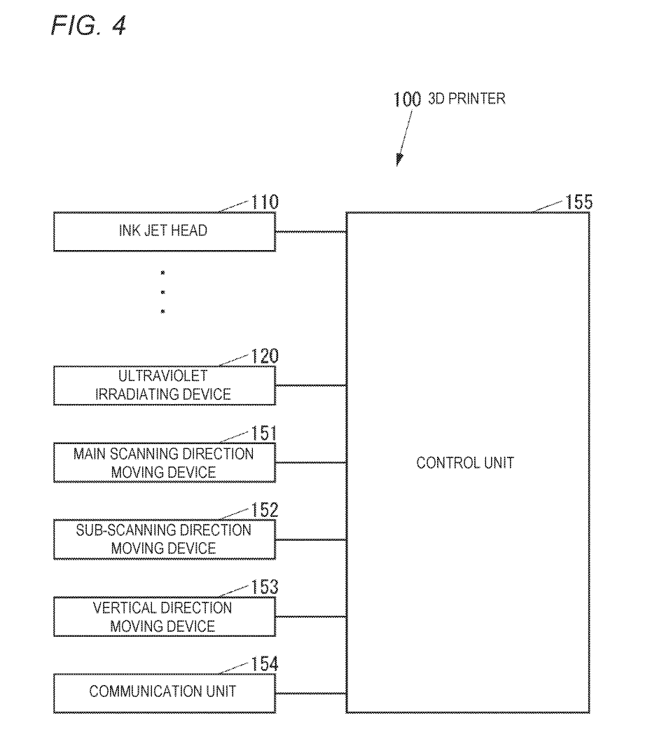

FIG. 4 is a block diagram of the 3D printer 100.

As shown in FIG. 4, the 3D printer 100 includes a main scanning direction moving device 151 that moves the carriage 130 in the main scanning direction, a sub-scanning direction moving device 152 that moves the carriage 130 in the sub-scanning direction, a vertical direction moving device 153 that moves the table 140 in the vertical direction, a communication unit 154, which is a communication device, that carries out communication with an external device directly in a wired or wireless manner without through a network such as a LAN (Local Area Network) and the like or through the network, and a control unit 155 that controls the entire 3D printer 100.

The control unit 155 includes, for example, a CPU (Central Processing Unit), a ROM (Read Only Memory) that stores in advance programs and various types of data, and a RAM (Random Access Memory) used as a work region of the CPU. The CPU executes the program stored in the ROM.

The control unit 155 controls the ink jet head 110, the ultraviolet irradiating device 120, the main scanning direction moving device 151, the sub-scanning direction moving device 152, and the vertical direction moving device 153 based on 3D data input through the communication unit 154. Specifically, every time the position of the carriage 130 in the sub-scanning direction with respect to the table 140 is changed by means of the sub-scanning direction moving device 152, the control unit 155 forms a layer extending in the horizontal direction with the shaping ink and the support ink by means of the ink jet head 110 and the ultraviolet irradiating device 120 while moving the carriage 130 in the main scanning direction with the main scanning direction moving device 151. Then, every time the position of the table 140 in the vertical direction with respect to the carriage 130 is changed by means of the vertical direction moving device 153, the control unit 155 layers a layer, extending in the horizontal direction formed with the shaping ink and the support ink, in the vertical direction by repeating the operations described above to form the 3D object and the support portion on the table 140.

If the 3D object attached with the support portion is formed, the worker can obtain the 3D object by removing the support portion from the 3D object.

After obtaining the frame 20, and the parts such as the parts 30, 40, and 50 as the 3D object through the three-dimensional printing carried out by the 3D printer 100 as described above, the worker can attach the parts to the frame 20 to obtain the three-dimensional object 10.

The worker can again separate the three-dimensional object into the frame 20 and each part such as the parts 30, 40, and 50 after installing the three-dimensional object 10. The worker may convey and store each separated part in a storage facility, or may convey and re-combine each separated part at a new installation site to install the three-dimensional object 10 at the new installation site.

As described above, the three-dimensional object 10 can be broken down by being divided into the frame 20 and the plurality of parts, and thus can be easily handled when being conveyed and installed compared to the conventional art even if the object is large.

The three-dimensional object 10 has not only the parts but also the frame 20 formed by the three-dimensional printing, and hence the degree of freedom of design can be enhanced.

In particular, in the three-dimensional object 10, the strength of the UV ink 110a which is the material configuring the frame 20, is made higher than the strength of the UV ink 110a which is the material configuring the parts, so that the frame 20 is formed with high strength, and the durability can be enhanced.

The frame 20 and the parts are manufactured through the three-dimensional printing 100 by the 3D printer 100 as described above, but may be manufactured through a method other than the three-dimensional printing by the 3D printer 100 such as, for example, FDM (Fused Deposition Modeling) method, powder method, 3D photolithography (shaping by spot irradiating container filled with liquid with laser light), and the like. For example, the frame 20 may be manufactured with metal through metal processing.

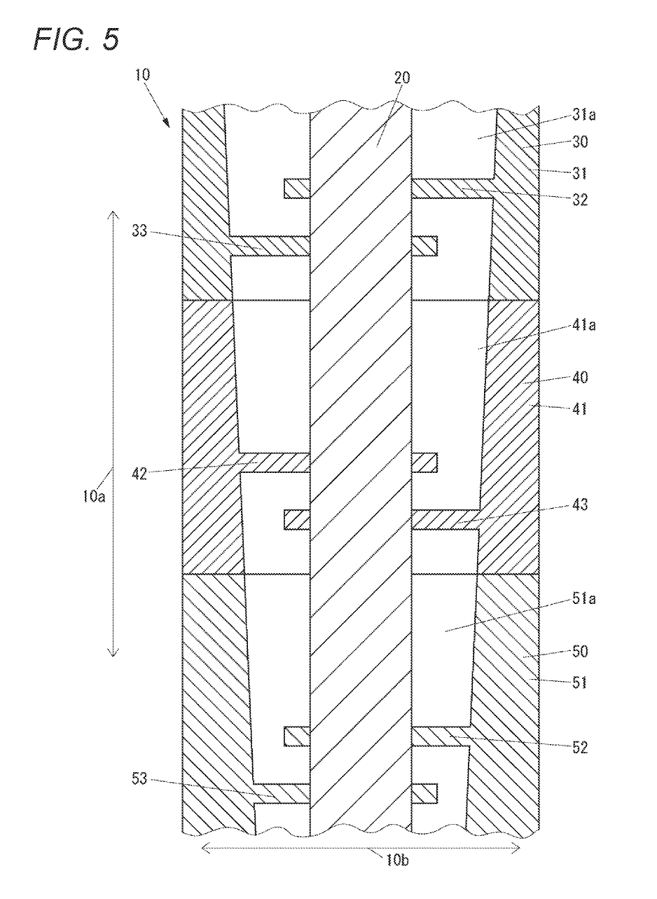

FIG. 5 is a front cross-sectional view of one part of the three-dimensional object 10 in an example different from the example shown in FIG. 1.

As shown in FIG. 5, when a plurality of parts are overlapped in the vertical direction indicated with the arrow 10a, a thickness in the horizontal direction indicated with the arrow 10b may become thicker toward the lower side in the vertical direction. When the plurality of parts are overlapped in the vertical direction, the thickness in the horizontal direction becomes thinner toward the upper side in the vertical direction of the parts, and hence the three-dimensional object 10 shown in FIG. 5 can be made lighter. Furthermore, when the plurality of parts are overlapped in the vertical direction, the thickness in the horizontal direction becomes thicker toward the lower side in the vertical direction of the parts, and hence the three-dimensional object 10 shown in FIG. 5 can easily support the weight on the upper side in the vertical direction with the lower side, and can also enhance the durability.

The thickness in the horizontal direction becomes thicker on the interior side of the three-dimensional object 10 toward the lower side in the vertical direction, and hence the three-dimensional object 10 shown in FIG. 5 can achieve lighter weight and enhancement of durability while maintaining the exterior shape. However, in the three-dimensional object 10, the thickness in the horizontal direction may become thicker on the exterior side of the three-dimensional object 10 toward the lower side in the vertical direction.

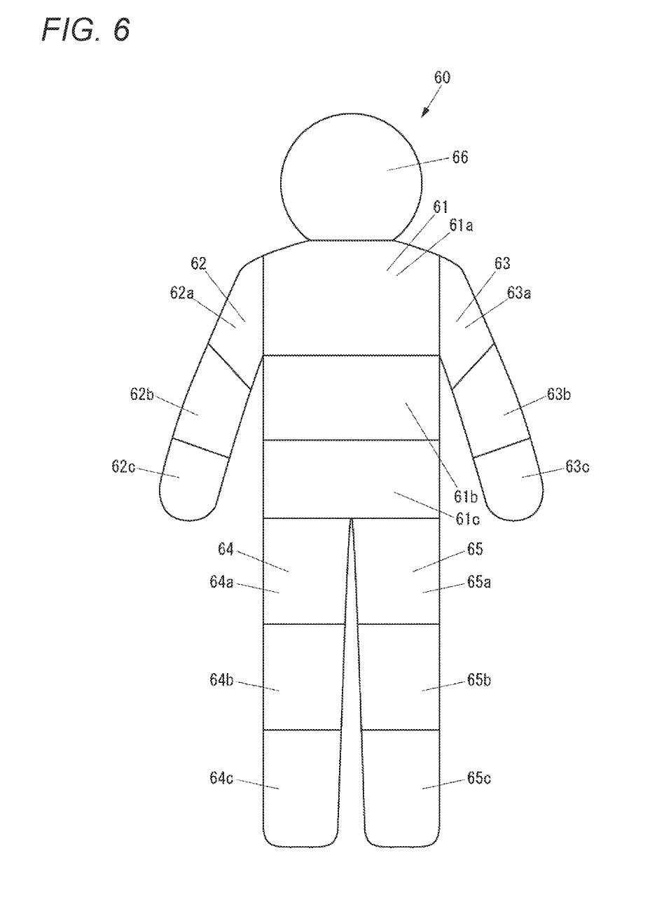

The three-dimensional object of the present disclosure may have a unit, in which a plurality of parts are combined, attached to a frame (not illustrated), as in for example, a three-dimensional object 60 shown in FIG. 6.

FIG. 6 is a front view of one part of the three-dimensional object 60.

The three-dimensional object 60 shown in FIG. 6 is a full scale human model.

As shown in FIG. 6, the three-dimensional object 60 includes a body portion 61, a right arm portion 62, a left arm portion 63, a right leg portion 64, a left leg portion 65, and a head portion 66. The body portion 61, the right arm portion 62, the left arm portion 63, the right leg portion 64, the left leg portion 65, and the head portion 66 are joined by being attached to a frame (not illustrated).

The body portion 61 includes parts 61a, 61b, and 61c. The parts 61a, 61b, and 61c are combined by being attached to the frame (not illustrated). The frame for combining the parts 61a, 61b, and 61c may be a frame different from a frame for combining the body portion 61, the right arm portion 62, the left arm portion 63, the right leg portion 64, the left leg portion 65, and the head portion 66.

Similarly, the right arm portion 62 is configured by attaching parts 62a, 62b, and 62c to the frame (not illustrated). The left arm portion 63 is configured by attaching parts 63a, 63b, and 63c to the frame (not illustrated). The right leg portion 64 is configured by attaching parts 64a, 64b, and 64c to the frame (not illustrated). The left leg portion 65 is configured by attaching parts 65a, 65b, and 65c to the frame (not illustrated).

The three-dimensional object 60 can be manufactured by manufacturing the body portion 61, in which the parts 61a, 61b, and 61c are unitized, the right arm portion 62, in which the parts 62a, 62b, and 62c are unitized, the left arm portion 63, in which the parts 63a, 63b, and 63c are unitized, the right leg portion 64, in which the parts 64a. 64b, and 64c are unitized, and the left leg portion 65, in which the parts 65a. 65b, and 65c are unitized, and then joining the body portion 61, the right arm portion 62, the left arm portion 63, the right leg portion 64, the left leg portion 65, and the head portion 66.

Similar to the three-dimensional object 10 (see FIG. 1), each part and the frame of the three-dimensional object 60 may be manufactured through the three-dimensional printing by the 3D printer 100 (see FIG. 3), or may be manufactured through a method other than the three-dimensional printing by the 3D printer 100 such as, for example, the FDM method, the powder method, the 3D photolithography (shaping by spot irradiating container filled with liquid with laser light), and the like.

In the three-dimensional object described above, the part includes a tubular body interiorly formed with the cavity, and at least one part of the frame is arranged inside the cavity of the part, so that the parts can be easily joined and the handling can be facilitated.

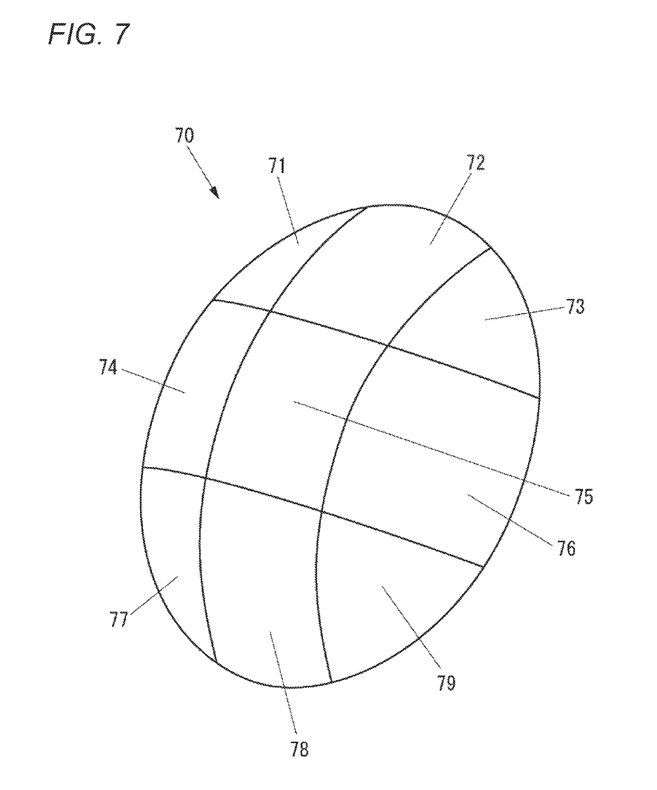

However, the three-dimensional object of the present disclosure may include a part other than the part including the tubular body interiorly formed with the cavity. For example, the three-dimensional object of the present disclosure may include a part other than the tubular body as in a three-dimensional object 70 shown in FIG. 7.

FIG. 7 is a perspective view of one part of the three-dimensional object 70 of when observed from an exterior side of the three-dimensional object 70.

As shown in FIG. 7, the three-dimensional object 70 includes parts 71 to 79.

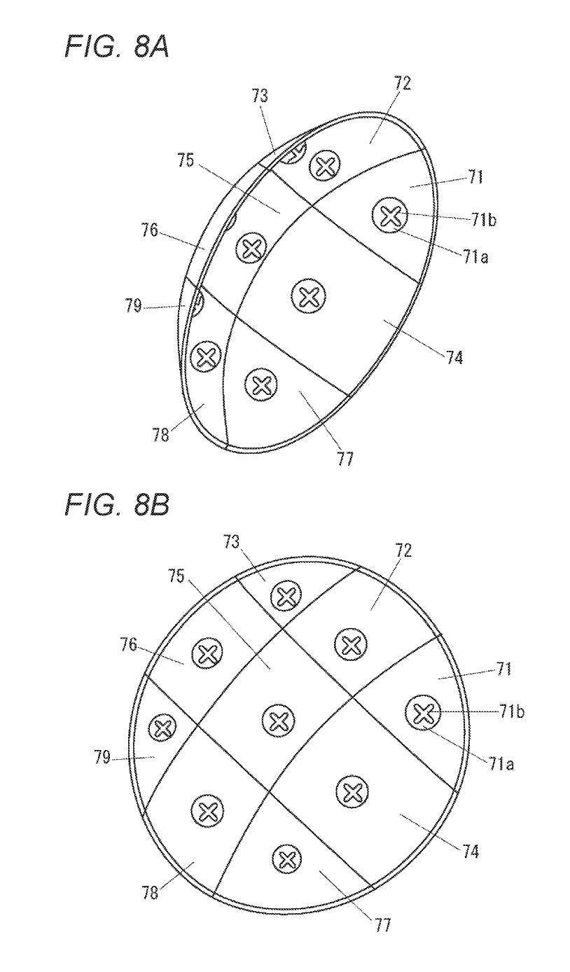

FIG. 8A is a perspective view of the parts 71 to 79 of when observed from an interior side of the three-dimensional object 70. FIG. 8B is a rear view of the parts 71 to 79 of when observed from the interior side of the three-dimensional object 70.

As shown in FIGS. 8A and 8B, the part 71 includes a protrusion 71a on the interior side of the three-dimensional object 70. The protrusion 71a has a cross-shaped groove 71b formed at the top. Similar to the part 71, the parts 72 to 79 also have a protrusion, in which the cross-shaped groove is formed at the top, on the interior side of the three-dimensional object 70.

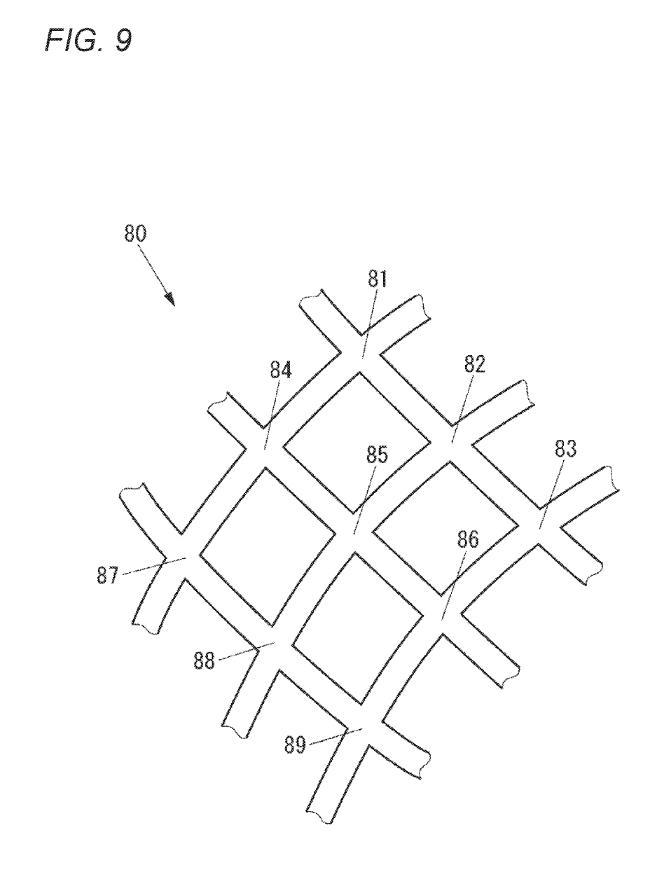

In FIGS. 8A and 8B, a state in which the parts 71 to 79 are brought into contact with each other is illustrated. However, the parts 71 to 79 does not need to be connected to each other if not attached to a frame 80 (see FIG. 9), to be described later.

FIG. 9 is a perspective view of one part of the frame 80 of the three-dimensional object 70 of when observed from the exterior side of the three-dimensional object 70 with the parts 71 to 79 (see FIGS. 8A and 8B) detached.

As shown in FIG. 9, the three-dimensional object 70 includes the frame 80. A plurality of bent rod-shaped members intersect at one part of the frame 80. The intersecting area is engagement portions 81 to 89 that each can be detachably attached to the groove of the protrusion of the part. In other words, the engagement portion 81 can be detachably attached to the groove 71b of the protrusion 71a of the part 71. The engagement portions 82 to 89 are respectively detachably attached to the grooves of the protrusions of the parts 72 to 79.

The three-dimensional object 70 shown in FIG. 7 is manufactured by attaching the parts 71 to 79 shown in FIGS. 8A and 8B to the frame 80 shown in FIG. 9.

In the three-dimensional object 70, the part includes the protrusion formed with the groove, and the frame includes the engagement portion that can be detachably attached to the groove of the part, and thus the detachment and attachment of the part with respect to the frame can be facilitated.

Similar to the three-dimensional object 10 (see FIG. 1), the parts 71 to 79 and the frame 80 of the three-dimensional object 70 may be manufactured through the three-dimensional printing by the 3D printer 100 (see FIG. 3), or may be manufactured through a method other than the three-dimensional printing by the 3D printer 100 such as, for example, the FDM method, the powder method, the 3D photolithography (shaping by spot irradiating container filled with liquid with laser light), and the like.

In the three-dimensional object 70 shown in FIG. 7, the part includes the protrusion formed with the groove, and the frame includes the engagement portion that can be detachably attached to the groove of the part. However, in the three-dimensional object 70, the frame may include the protrusion formed with the groove, and the part may include the engagement portion that can be detachably attached to the groove of the frame.

What is claimed is:

1. A three-dimensional object comprising:
a frame; and
a plurality of parts to be attached to the frame.

2. The three-dimensional object according to claim 1, wherein
the part includes a tubular body interiorly formed with a cavity, and
at least one part of the frame is arranged in the cavity.

3. The three-dimensional object according to claim 1, wherein when the plurality of parts are overlapped in a vertical direction, a thickness in a horizontal direction becomes thicker toward a lower side in the vertical direction.

4. The three-dimensional object according to claim 3, wherein when the plurality of parts are overlapped in the vertical direction, the thickness in the horizontal direction becomes thicker on an interior side of the three-dimensional object toward the lower side in the vertical direction.

5. The three-dimensional object according to claim 1, wherein
one of the frame or the part includes a protrusion formed with a groove, and
the other one of the frame or the part includes an engagement portion detachably attached to the groove.

6. A three-dimensional object manufacturing method for manufacturing the three-dimensional object according to claim 1, wherein the frame and the part are formed by three-dimensional printing.

7. The three-dimensional object manufacturing method according to claim 6, wherein a material configuring the frame has higher strength than a material configuring the part.

8. The three-dimensional object according to claim 2, wherein when the plurality of parts are overlapped in a vertical direction, a thickness in a horizontal direction becomes thicker toward a lower side in the vertical direction.

9. The three-dimensional object according to claim 8, wherein when the plurality of parts are overlapped in the vertical direction, the thickness in the horizontal direction becomes thicker on an interior side of the three-dimensional object toward the lower side in the vertical direction.

10. The three-dimensional object according to claim 2, wherein
one of the frame or the part includes a protrusion formed with a groove, and
the other one of the frame or the part includes an engagement portion detachably attached to the groove.

11. The three-dimensional object according to claim 3, wherein
one of the frame or the part includes a protrusion formed with a groove, and
the other one of the frame or the part includes an engagement portion detachably attached to the groove.

12. The three-dimensional object according to claim 4, wherein
one of the frame or the part includes a protrusion formed with a groove, and
the other one of the frame or the part includes an engagement portion detachably attached to the groove.

13. The three-dimensional object according to claim 8, wherein
one of the frame or the part includes a protrusion formed with a groove, and
the other one of the frame or the part includes an engagement portion detachably attached to the groove.

14. The three-dimensional object according to claim 9, wherein
one of the frame or the part includes a protrusion formed with a groove, and
the other one of the frame or the part includes an engagement portion detachably attached to the groove.

15. A three-dimensional object manufacturing method for manufacturing the three-dimensional object according to claim 2, wherein the frame and the part are formed by three-dimensional printing.

16. A three-dimensional object manufacturing method for manufacturing the three-dimensional object according to claim 3, wherein the frame and the part are formed by three-dimensional printing.

17. A three-dimensional object manufacturing method for manufacturing the three-dimensional object according to claim 4, wherein the frame and the part are formed by three-dimensional printing.

18. A three-dimensional object manufacturing method for manufacturing the three-dimensional object according to claim 5, wherein the frame and the part are formed by three-dimensional printing.

19. A three-dimensional object manufacturing method for manufacturing the three-dimensional object according to claim 8, wherein the frame and the part are formed by three-dimensional printing.

20. A three-dimensional object manufacturing method for manufacturing the three-dimensional object according to claim 9, wherein the frame and the part are formed by three-dimensional printing.
